(19) United States
(12) Patent Application Publication
(10) Pub. No.: US 2007/0019972 A1
(43) Pub. Date: Jan. 25, 2007

(54) Image recording apparatus

(75) Inventors: Haruhiko Arai, Kanagawa (JP); Noboru Kinomoto, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/489,502

(22) Filed: Jul. 20, 2006

(30) Foreign Application Priority Data
Jul. 22, 2005 (JP) 2005-212866

(51) Int. Cl. G03G 15/00; G03G 15/20

(52) U.S. Cl. 399/16; 399/341

(57) ABSTRACT

An image recording apparatus includes a surface treatment unit for performing surface treatment using a belt on a surface of a recording sheet, a discriminating unit for detecting whether the sheet exists in the treatment unit and discriminating whether the sheet is the surface-treatable recording sheet, a site identifying unit for detecting occurrence of abnormality and identifying an abnormality occurrence site and a control unit for controlling, when the occurrence of the abnormality has been detected, driving of the treatment unit, driving of an upstream unit on an upstream side of the treatment unit, and driving of a downstream unit on a downstream side thereof, in accordance with the identified site, a result of the detection of whether the sheet exists in the treatment unit, and a result of the discrimination of whether the sheet is the surface-treatable recording sheet.

The entire contents of documents cited in this specification are incorporated herein by reference.

### BACKGROUND OF THE INVENTION

The present invention relates to an image recording apparatus having a function of imparting glossiness to a recording sheet on which an image has been recorded using an electrophotographic recording system, a silver halide photographic system, an ink jet recording system, a thermal recording system, or the like, through a fixing belt whose surface is smooth. In particular, the present invention relates to an image recording apparatus capable of preventing damage of a fixing belt from occurring at the time of occurrence of abnormality such as recording sheet jamming.

It is known that in electrophotographic image formation or the like, prints having glossiness that is equal to that of photographic prints are produced using an image recording medium obtained by forming a transparent resin layer made of a thermoplastic resin on a surface of a substrate.

In the print production, after recording of images on the image recording medium or transparent resin layer, a surface of the image recording medium is smoothened by melting and then solidifying the transparent resin layer through surface treatment based on heating/pressurizing, thereby imparting glossiness to the image recording medium.

For instance, in JP 2004-109860 A, as an apparatus for imparting glossiness to a print obtained by forming a transparent resin layer on a surface of a substrate, a glossing treatment device is disclosed which includes an endless belt, whose surface is smooth, and heating and pressurizing means for bringing an image receiving medium into intimate contact with the endless belt or roller stretching the belt and heating the image receiving medium.

More specifically, in JP 2004-109860 A, a printer is disclosed which uses the glossing treatment device including the endless belt stretched by the rollers including a heating roller and having high surface smoothness, a nip roller, which contains a heat source, for abutting an image recording medium against the endless belt or heating roller, and a cooling device contained in the endless belt.

In the printer disclosed in JP 2004-109860 A, after an image has been recorded by the electrophotographic system using the image receiving medium having the transparent resin layer on the surface thereof, in the glossing treatment device, the image receiving medium is nipped and conveyed between the endless belt and a nip roller in a state where the transparent resin layer, i.e., image recording surface is directed toward the endless belt. Through the nipping and conveying, the transparent resin layer is pressed against the endless belt and is heated/melted. Next, the transparent resin layer is cooled/solidified and is then peeled off from the endless belt. In this manner, the surface properties of the endless belt are transferred to the transparent resin layer of the image receiving medium and glossiness is imparted to the surface of the print.

In the various kinds of image recording apparatuses, as a measure against abnormality such as jamming, which has occurred during image formation on a recording sheet, various methods are used. Examples thereof include a method with which every operation in the image recording apparatus is stopped immediately, an error message is displayed, and a user removes the recording sheet in the apparatus, and a method with which an abnormality occurrence site is identified, an operation at a site on an upstream side with respect to the abnormality occurrence site is stopped immediately and an error message is displayed, and an operation at a site on a downstream side with respect to the abnormality occurrence site is performed continuously, and is then stopped after every recording sheet existing at the site on the downstream side has been conveyed to the outside of the apparatus.

However, in the image recording apparatus including the glossing treatment device as described above, when abnormality occurs and the operation is stopped in a state where the recording sheet exists in the glossing treatment device, the glossing treatment device is stopped in a state where the recording sheet and the belt contact with each other under pressure. Here, in the glossing treatment device, the thermoplastic resin of the recording sheet is melted through the heating/pressurizing, so while the conveying in the glossing treatment device is being stopped, the melted thermoplastic resin sticks to the belt, which leads to a problem that the smoothness of the surface of the belt is lost and it becomes impossible to perform the surface treatment appropriately from then on.

### SUMMARY OF THE INVENTION

An object of the present invention is to solve the problems of the conventional techniques described above and to provide an image recording apparatus for performing surface treatment such as glossing treatment using a belt, with which it becomes possible to accurately perform control at a time of occurrence of abnormality so that performance of a surface treatment device will not be impaired.

In order to attain the object described above, the present invention provides an image recording apparatus including: image recording means for recording an image on a surface of a recording sheet; surface treatment means for performing surface treatment using a belt on the surface of the recording sheet on which the image is recorded when the recording sheet is a surface-treatable recording sheet having a surface on which the surface treatment can be performed; recording sheet discriminating means for detecting whether the recording sheet exists in the surface treatment means and discriminating whether the recording sheet in the surface treatment means is the surface-treatable recording sheet; abnormality occurrence site identifying means for detecting occurrence of abnormality and identifying an abnormality occurrence site; and control means for controlling, when the occurrence of the abnormality has been detected by the abnormality occurrence site identifying means, driving of the surface treatment means, driving of an upstream unit having the image recording means on an upstream side with respect to the surface treatment means, and driving of a downstream unit on a downstream side with respect to the surface treatment means, in accordance with the abnormality occurrence site identified by the abnormality occurrence site identifying means, a result of the detection by the recording sheet discriminating means of whether the recording sheet exists in the surface treatment means, and a result of the discrimination by the recording sheet discriminating means of whether the recording sheet in the surface treatment means is the surface-treatable recording sheet.

In the image recording apparatus according to the present invention, it is preferable that, when the abnormality occurrence site identifying means detects the occurrence of the abnormality and the recording sheet discriminating means detects that no recording sheet exists in the surface treatment means, the control means stops conveyance at least at the upstream unit.

Also, in the image recording apparatus according to the present invention, it is preferable that, when the abnormality occurrence site identifying means detects the occurrence of the abnormality, the recording sheet discriminating means detects that the recording sheet corresponding to the surface-treatable recording sheet exists in the surface treatment means, and the abnormality occurrence site identifying means identifies that an abnormality occurrence site is the upstream unit, the control means stops the driving of the upstream unit and drives the surface treatment means until the recording sheet has been discharged.

Further, in the image recording apparatus according to the present invention, it is preferable that, when the abnormality occurrence site identifying means detects the occurrence of the abnormality, the recording sheet discriminating means detects that the recording sheet corresponding to the surface-treatable recording sheet exists in the surface treatment means, and the abnormality occurrence site identifying means identifies that the abnormality occurrence site is the downstream unit, the control means stops the driving of the upstream unit, switches a conveying path using a conveying path switching guide provided on a downstream side of the surface treatment means, and discharges the recording sheet in the surface treatment means to a predetermined discharging portion.

Still further, in the image recording apparatus according to the present invention, it is preferable that, when the abnormality occurrence site identifying means detects the occurrence of the abnormality and the recording sheet discriminating means detects that the recording sheet not corresponding to the surface-treatable recording sheet exists in the surface treatment means, the control means stops all the conveyances at the upstream unit, the downstream unit, and the surface treatment means.

Alternatively, it is preferable that, when the abnormality occurrence site identifying means detects the occurrence of the abnormality and the recording sheet discriminating means detects that the recording sheet not corresponding to the surface-treatable recording sheet exists in the surface treatment means, the control means stops the conveyance on the upstream side with respect to the abnormality occurrence site identified by the abnormality occurrence site identifying means, and drives the downstream side with respect to the abnormality occurrence site identified by the abnormality occurrence site identifying means until the recording sheet has been discharged.

According to the present invention, in the image recording apparatus for performing the surface treatment such as the glossing treatment of the recording sheet using a surface treatment belt, when the abnormality such as jamming occurs, the driving of the surface treatment means, the driving of the upstream portion with respect to the surface treatment means, and the driving of the downstream portion with respect to the surface treatment means are controlled in accordance with whether the abnormality occurrence site is on the upstream side or the downstream side with respect to the surface treatment means, whether the recording sheet exists in the surface treatment means, whether the recording sheet in the surface treatment means corresponds to the surface-treatable recording sheet, and the like.

Therefore, according to the present invention, when the abnormality occurs, it becomes possible to prevent the conveyance in the surface treatment apparatus from being stopped under a state where an image recording medium exists. Accordingly, it becomes possible to prevent occurrence of an inconvenience, such as deterioration in smoothness of the surface treatment belt ascribable to stoppage of the surface treatment means or the like, under a state where the image recording medium is heated/pressurized. In addition, it becomes possible to perform efficient after treatment.

### BRIEF DESCRIPTION OF THE DRAWINGS

In the accompanying drawings:

FIG. 1 is a conceptual diagram of an example of an image recording apparatus according to the present invention;

FIG. 2 is a schematic diagram showing constructions of a surface treatment section and a cutting/arranging section of an image recording apparatus according to an embodiment of the present invention; and

FIGS. 3A and 3B are each a conceptual diagram showing an example of image recording in the image recording apparatus shown in FIG. 1.

### DETAILED DESCRIPTION OF THE PREFERRED EMBODIMENTS

An image recording apparatus according to the present invention will be described below in detail based on preferred embodiments with reference to the accompanying drawings.

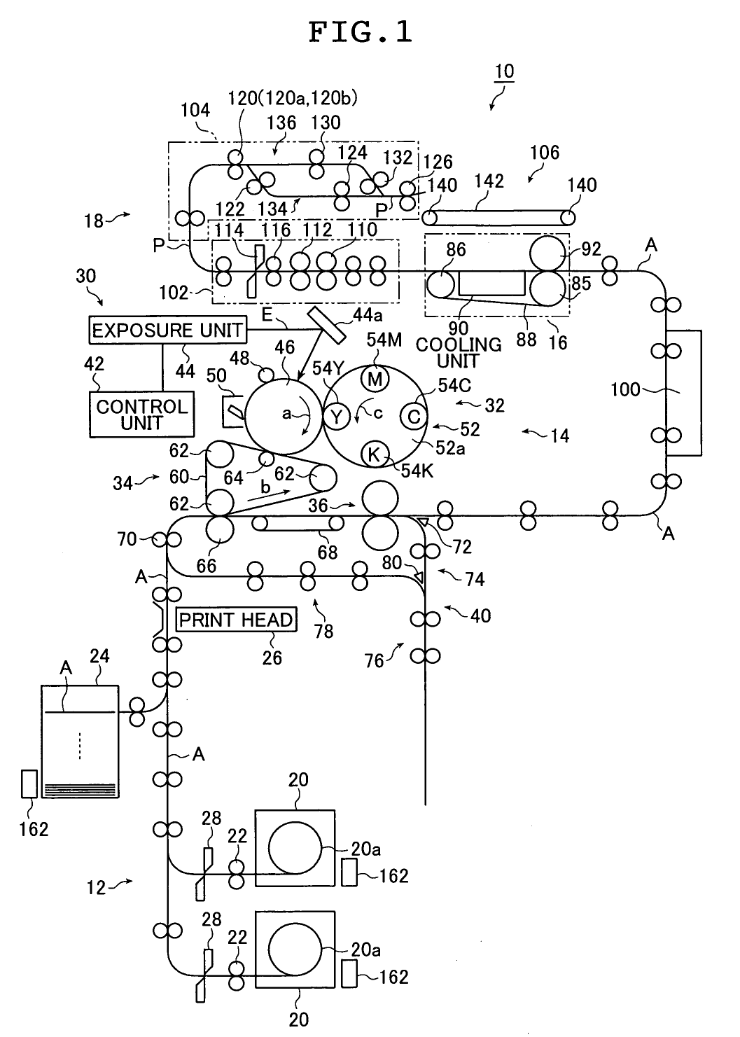

FIG. 1 is a conceptual diagram of an example of the image recording apparatus according to the present invention.

An image recording apparatus 10 shown in FIG. 1 produces a print by recording an image on a recording sheet A or image receiving medium by an electrophotographic system, and basically includes a recording sheet supplying section 12, an image forming section 14, a surface treatment section 16, and a cutting/arranging section 18. Various members arranged in commonly known printers as exemplified by means for conveying the recording sheet A (such as a conveying roller pair and a guide member), a sensor for detecting the recording sheet A, and a sensor for detecting jamming of sheets are also disposed as necessary in these sections or between the adjacent sections, although they are not specifically shown or denoted by reference numerals. Also, in the image recording apparatus 10, an upstream unit is composed of the sites and the members on the upstream of the surface treatment section 16 (e.g., the recording sheet supplying section 12, the image forming section 14, the members disposed in and between the recording sheet supplying section 12 and the image forming section 14, and the members disposed between the image forming section 14 and the surface treatment section 16), and a downstream unit is composed of the sites and the members on the downstream of the surface treatment section 16 (e.g., the cutting/arranging section 18, the members disposed in the cutting/arranging section 18, and the members disposed between the cutting/arranging section 18 and the surface treatment section 16). The surface treatment section 16, the upstream unit, and the downstream unit are set so that driving thereof can be controlled independently of each other.

It should be noted here that the sections and members are controlled by a control unit 42 to be described later.

The image recording apparatus 10 obtains finished prints by recording images corresponding to print sizes on a recording sheet A and then cutting the recording sheet A into the print sizes. Also, in the illustrated example, as a preferable form, the image recording apparatus 10 imposes multiple images (e.g., two images or four images) on one recording sheet A, i.e., performs so-called multi-image imposition, according to need, and thereafter cuts and slits the recording sheet A according to the print sizes of the images to produce multiple prints from one recording sheet A.

In the image recording apparatus 10, in order to prevent contamination of an apparatus due to unfixed toner or the like, it is preferable to form images on the recording sheet A whose periphery (including the forward and rear ends in the conveying direction and both the lateral ends in a direction orthogonal to the conveying direction) is blank. When images are formed by performing the multiple-image imposition, it does not matter whether spaces are formed between the adjacent images or not.

In the following description, for convenience' sake, the direction orthogonal to the conveying direction will be referred to as the “width direction” and the size of the recording sheet A in this direction will be referred to as the “width”. Also, the size of the recording sheet A in the conveying direction will be referred to as the “length”. Further, the forward end and the rear end are determined with respect to the conveying direction.

The recording sheet supplying section 12 (hereinafter referred to as the “supplying section 12”) is a section for supplying the cut recording sheet A to the image forming section 14.

In the illustrated example, the supplying section 12 includes two loading units into which magazines 20 each accommodating a recording sheet roll 20a of the elongated recording sheet A is loaded, and a loading unit into which a cassette 24 accommodating the cut recording sheets A is loaded.

The loading units for the magazines 20 usually accommodate the recording sheet rolls 20a whose widths or sizes are different from each other. On the other hand, the cassette 24 is a case as used in various printers, which is loaded into the printer after accommodating the recording sheets A.

The recording sheet A is not specifically limited and all kinds of recording sheet or image receiving medium used in a printer adopting an electrophotographic system is applicable.

In the image recording apparatus 10 according to the present invention, a recording sheet from which a highly glossy print of photographic quality can be produced (hereinafter also referred to as a photo-like print sheet), that is, the surface-treatable recording sheet such as a recording sheet obtained by forming a transparent resin layer made of a thermoplastic resin on a surface of a substrate made of paper or the like, is particularly suitable. For example, this recording sheet can be used to produce a highly glossy print like a silver halide photographic print by forming a toner image on the image forming surface of the transparent resin layer, applying heat and pressure to the transparent resin layer with a belt having an excellent surface smoothness to melt, and cooling and solidifying the transparent resin layer thereby transferring the surface properties of the belt (the toner image may be optionally fixed) (see JP 05-216322 A).

The thermoplastic resin that may be used for the transparent resin layer is not specifically limited but preferred examples thereof include polyester resin, polyethylene resin, and styrene-acrylic ester resin. The thickness of the transparent resin layer is not specifically limited but it is preferable that the layer thickness be in a range of 5 to 20 μm in order to prevent strain under stress (bending strain) from causing breakage (cracking) after the surface treatment.

Although not illustrated, each loading unit includes loaded sheet kind detecting means 162 for detecting the size (i.e. width) and recording sheet kind of the recording sheet roll 20a accommodated in a corresponding magazine 20 and the size and recording sheet kind of the recording sheet A accommodated in the cassette 24.

In the image recording apparatus 10, with the loaded sheet kind detecting means 162, the size of each recording sheet A used for print production and the kind of the recording sheet A, for instance, whether the recording sheet A is the photo-like print sheet described above or plain paper, are detected. Also, the result of the detection by the loaded sheet kind detecting means 162 is supplied to the control unit 42 to be described later.

It should be noted here that a method used by the loaded sheet kind detecting means 162 to detect the kind and size of the recording sheet A is not specifically limited and various methods used in printers, such as a method utilizing a DIP switch and a method utilizing a barcode, are usable.

A drawing-out roller pair 22 and a cutter 28 are disposed downstream of each magazine 20 loaded into one of the loading units (i.e., downstream in the conveying direction of the recording sheet A).

The drawing-out roller pair 22 is a roller pair with which the recording sheet is drawn out of the recording sheet roll 20a accommodated in the magazine 20. The cutter 28 is known means for cutting sheets such as a guillotine cutter.

The drawing-out roller pair 22 stops drawing out the recording sheet from the recording sheet roll 20a when the recording sheet on the downstream side of the cutter 28 has a predetermined length. Next, the cutter 28 cuts the recording sheet into a predetermined size and the thus cut recording sheet A is supplied to predetermined conveying means.

The recording sheet A accommodated in the cassette 24 is drawn out by known means used in various printers and is supplied to predetermined conveying means.

The recording sheet A cut into the predetermined size with the cutter 28 and the recording sheet A drawn out from the cassette 24 are both conveyed to the image forming section 14 through conveying roller pairs.

A printing head 26 is disposed between two conveying roller pairs immediately upstream of the image forming section 14. The printing head 26 performs back printing on the back surface (i.e. non-image-recording surface) of the recording sheet based on the control signal from the control unit 42 to be described later.

The printing head 26 is not specifically limited and various known printing means such as an impact printer using an ink ribbon and an ink jet printer are usable.

The image forming section 14 is a section where images are formed on the recording sheet A by electrophotography and includes an exposure subsection 30, a toner image forming subsection 32, a transferring subsection 34, a primary fixing roller pair 36, and a reversing subsection 40.

The exposure subsection 30 includes a control unit 42 and an exposure unit 44.

The control unit 42 acquires images (i.e., image data) to be reproduced on prints from an image supply source, carries out predetermined image processing, and performs an image layout in accordance with the number of images to be recorded (i.e., the number of images for imposition) on one the recording sheet A, thereby preparing images to be recorded on the one recording sheet A.

Also, the control unit 42 performs an operation control of each construction element of the image recording apparatus 10.

Further, when abnormality (trouble) such as jamming occurs in the image recording apparatus 10, the control unit 42 identifies the occurrence position of the abnormality with reference to the result of detection by the sensor for detecting the jamming, the recording sheet A, or the like, and controls driving of the upstream unit, driving of the surface treatment section 16, and driving of the downstream unit in accordance with the occurrence position of the abnormality, the presence or absence of the recording sheet A in the surface treatment section 16 detected by recording sheet detecting means 160 of the surface treatment section 16 to be described later, the kind of the recording sheet A in the surface treatment section 16 found as a result of the detection by the loaded sheet kind detecting means 162, and the like. This point will be described in detail later.

On the other hand, the exposure unit 44 is a known light beam scanning optical system including a light source of a light beam (i.e., recording light) for exposing an electrophotographic photosensitive drum 46 of the toner image forming subsection 32 to be described later, a light deflector, an fθ lens, an optical path changing mirror, a light beam adjusting lens, and the like.

That is, the exposing unit 44 deflects a light beam E modulated in accordance with image data (i.e. images to be recorded) supplied from the control unit 42 in a main scanning direction coinciding with the width direction (i.e. direction orthogonal to the conveying direction (in which the electrophotographic photosensitive drum 46 rotates). The deflected light beam E is emitted to and then reflected on a mirror 44a to be incident on the drum 46 at a predetermined exposure position, thereby recording a latent image on the electrophotographic photosensitive drum 46.

The toner image forming subsection 32 is a known device in which a toner image is formed by electrophotography and includes the electrophotographic photosensitive drum 46 (hereinafter referred to as the “photosensitive drum 46”), charging means 48, cleaning means 50, and toner supplying means 52.

The photosensitive drum 46 is a known electrophotographic photosensitive drum and is rotated in a direction of arrow “a” (i.e., direction opposite to the conveying direction of the recording sheet A) about a center axis coinciding with the width direction. As described above, the light beam E from the exposure unit 44 is deflected in the width direction, so the photosensitive drum 46 is two-dimensionally scanned by exposure to the light beam E modulated in accordance with the image to be recorded.

The toner supplying means 52 includes four toner supplying units that are a cyan (C) toner supplying unit 54C, a magenta (M) toner supplying unit 54M, a yellow (Y) toner supplying unit 54Y, and a black (K) toner supplying unit 54K, with the toner supplying units being attached to a rotatable drum-shaped main body 52a at intervals of a 90° rotation angle.

The transferring subsection 34 includes a transfer belt 60 that is an endless belt partially abutted against the photosensitive drum 46, three rollers 62 around which the transfer belt 60 is stretched, a press roller 64 which presses the transfer belt 60 outward against the photosensitive drum 46, a transfer roller 66, and a belt conveyor 68. The transfer belt 60 is an intermediate transfer member of the toner image and is rotated in a direction of arrow “b” (that is, the same direction as the direction in which the recording sheet A is conveyed). The transfer roller 66 is movable between the position at which the transfer belt 60 (i.e., recording sheet A) is nipped between the transfer roller 66 and one of the rollers 62, and the position at which the transfer roller 66 is spaced apart from the transfer belt 60.

While being rotated in the direction of the arrow “a” in FIG. 1, the photosensitive drum 46 is uniformly charged in the width direction by the charging means 48 and is two-dimensionally scanned by exposure to the light beam E modulated in accordance with the image data as described above, thereby forming an electrostatic latent image. Next, the electrostatic latent image is developed by one of the toner supplying units of the toner supplying means 52, such as the Y toner supplying unit 54Y, which is positioned at the developing position (i.e. at the position facing the photosensitive drum 46) and a toner image such as a Y toner image is formed on the surface of the photosensitive drum 46.

The transfer belt 60 that partially contacts the photosensitive drum 46 and is pressed by the press roller 64 against the photosensitive drum 46 is rotated in the direction of the arrow “b” in synchronization with the rotation of the photosensitive drum 46. Accordingly, the toner image on the photosensitive drum 46 developed by the toner supplying means 52 is transferred onto the transfer belt 60 in the contact portion (at which the press roller 64 presses the belt) After the toner image on the photosensitive drum 46 has been transferred onto the transfer belt 60, the cleaning means 50 removes residual toner from the photosensitive drum 46.

In the illustrated embodiment, formation of toner images and their transfer onto the transfer belt 60 are performed by sequentially actuating the four toner supplying units including the Y toner supplying unit 54Y, the M toner supplying unit 54M, the C toner supplying unit 54C, and the K toner supplying unit 54K.

For example, after the Y toner image has been transferred onto the transfer belt 60 as described above, the toner supplying means 52 (more specifically its main body 52a) is rotated in a direction of an arrow “c” shown in FIG. 1 by 90° so as to make the M toner supplying unit 54M positioned at the developing position. After performing positioning to match an M toner image with the Y toner image on the transfer belt 60, a latent image is formed on the surface of the photosensitive drum 46, and the M toner image is formed on the surface of the photosensitive drum 46 to be transferred onto the transfer belt 60 in the same manner as described above. Thereafter, in the same way, a C toner image and a K toner image are transferred onto the transfer belt. Note that the transfer roller 66 is separated from the transfer belt 60 during the above operation.

Accordingly, in the illustrated embodiment, the Y, M, C, and K toner images are formed on the surface of the transfer belt 60 after positioning. In other words, a four-color (that is, a full-color) toner image is formed.

On the other hand, the recording sheet A cut into a predetermined size is supplied from the supplying section 12 and is placed under a standby state, for example, at a registration roller pair 70 immediately upstream of the transfer roller 66.

When a color image has been formed on the transfer belt 60, conveyance of the recording sheet A through the registration roller pair 70 is started in synchronization with the rotation of the transfer belt 60 so that the recording sheet A coincides in position with the color image formed on the transfer belt 60. In addition, the transfer roller 66 is pressed against the transfer belt 60 (roller 62) and the recording sheet A is conveyed while being nipped between the transfer belt 60 and the transfer roller 66. As a result of conveyance of the nipped recording sheet, four-color toner images formed on the surface of the transfer belt 60 are transferred onto the recording sheet A and a total image (including plural images) is formed on the surface of the recording sheet A.

As described above, the total image includes plural images imposed in accordance with the number of images to be recorded.

The recording sheet A on which the image has been formed is conveyed on the belt conveyor 68 to the primary fixing roller pair 36.

The primary fixing roller pair 36 is a pair of conveying rollers, at least one of which is a heating roller. The primary fixing roller pair 36 may be moved as required by a method of vertically moving the roller on the image forming surface side so as to take the position in which the recording sheet A is nipped and the position in which it is released.

As in the case in which an image formed by common electrophotographic system is fixed, the primary fixing roller pair 36 nips and conveys the recording sheet A on which the toner images have been formed through image transfer in the transferring subsection 34, whereby the toner images are fixed by heating under pressure.

The image forming method used in the image recording apparatus 10 according to the present invention is not limited to the electrophotographic image forming method as in the illustrated embodiment and any known image forming method is usable.

For instance, image recording methods implemented in various known printers (printing means) including a printer that has a heat development step and uses a thermally developable photosensitive material as the image receiving medium on which images are formed in the presence of an image forming solvent such as water; an ink jet printer; and a thermal printer using a thermal head are usable.

The reversing subsection 40 is a subsection in which the recording sheet A on which images have been fixed by the primary fixing roller pair 36 are reversed to produce so-called double-sided prints.

In the illustrated example, the reversing subsection 40 includes first switching means 72 disposed downstream of the primary fixing roller pair 36, a branching path 74 branching from the conveying path at the downstream position of the primary fixing roller pair 36, a kickback unit 76 provided downstream of the branching path 74, a return conveying path 78 that branches from the branching path 74 and the kickback unit 76 to return to the registration roller pair 70 upstream of the transferring subsection 34, and second switching means 80 provided at the branch point between the kickback unit 76 and the return conveying path 78.

The first switching means 72 and the second switching means 80 are each known means for switching the sheet conveying path such as a flapper that acts on the conveying path (or is inserted in the conveying path) to guide the recording sheet A to a predetermined conveying path.

When a double-sided print is produced in the printer 10, the first switching means 72 is caused to act on the conveying path on the downstream side from the primary fixing roller pair 36 to convey the recording sheet A on which an image has been fixed by the primary fixing roller pair 36 to the kickback unit 76 through the branching path 74. Then, when the upstream end of the recording sheet A has reached the downstream side of the second switching means 80, the conveyance is stopped.

Next, the second switching means 80 is caused to act on the kickback unit 76 to change the conveying direction at the kickback unit 76 and the recording sheet A is conveyed to the return conveying path 78 in a direction opposite to the above direction while guided by the second switching means 80 and is further conveyed from the return conveying path 78 to the registration roller pair 70. In this manner, the front surface and the rear surface of the recording sheet are reversed.

The reversing subsection 40 may be provided by branching the conveying path from the downstream of the surface treatment section 16 instead of branching it from the downstream of the primary fixing roller pair 36.

The recording sheet A having the image fixed thereon by the primary fixing roller pair 36 is then conveyed to the position adjusting section 100 in which a position in the width direction of the recording sheet A is adjusted. Thereafter, the recording sheet A is conveyed to the surface treatment section 16.

As described above, in the image recording apparatus 10, one or more images are imposed on the recording sheet A (image imposition), and the recording sheet A is cut into individual images (prints) at a cutting subsection 102 to be described later according to the print sizes, thereby producing prints to be outputted as products.

The position adjusting section 100 is a section for adjusting the position in the width direction of the recording sheet A on which the image has been formed to a predetermined position in accordance with information showing the width of the recording sheet A, information showing an image forming position, and the like, in order to perform the cutting appropriately and prevent damage or the like of a specific site of the surface treatment belt 88 which is ascribable to abutment of the recording sheet A against only a specific area of the surface treatment belt 88.

There is no limit to the position adjusting means of the recording sheet A in the width direction in the position adjusting section 100, and various known position adjusting means for a sheet-like material can be used.

Examples of the position adjusting means include means that applies a method in which a guide plate is used to regulate the position of the recording sheet A in the width direction by contacting the side end of the recording sheet A thereto, a method in which a conveying roller pair having a position adjusting function in the axis direction is used to move the recording sheet A in the width direction while nipping it, and the like.

The surface treatment section 16 is disposed downstream of the position adjusting section 100.

The surface treatment section 16 performs the surface treatment to the recording sheet A (and optionally secondary fixation of the toner image) when the above mentioned photo-like print sheet is used for the recording sheet A to produce a high-quality print having glossiness and the like equal to that of a silver halide photograph. To be more specific, the surface treatment section 16 performs the surface treatment as follows: The surface of the recording sheet A (i.e., image forming surface) is abutted and pressed against the belt-shaped surface treatment means to be heated, and thereafter is cooled.

Usually, print production using plain paper does not require the surface treatment and the fixing treatment in the surface treatment section 16, so the recording sheet A is passed through the surface treatment section 16 without any treatment. Alternatively, when no cutting operation is required in the subsequent cutting/arranging section 18, the recording sheet may be outputted to a predetermined tray as a print immediately after the fixation by the primary fixing roller pair 36 has been finished.

In the present invention, however, if necessary, the surface treatment described below may be carried out not only on the photo-like print sheet but also on various other recording sheets A such as plain paper.

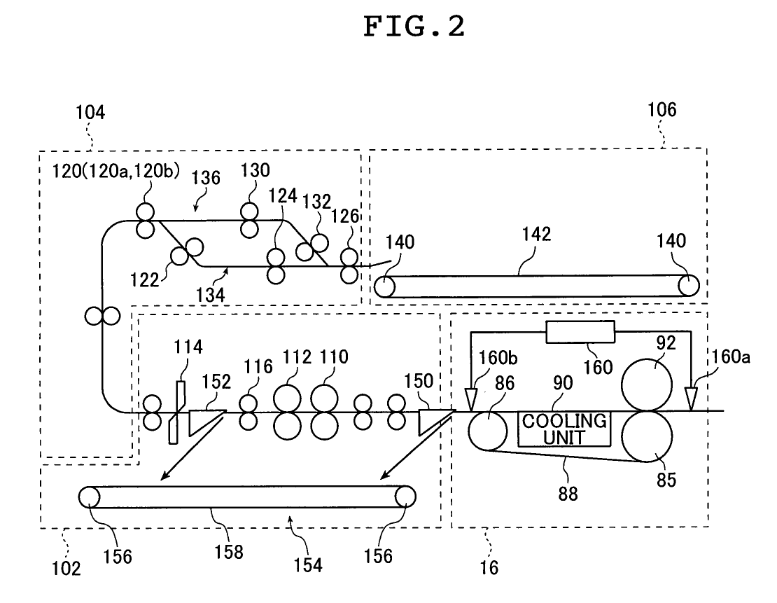

As shown in FIGS. 1 and 2, the surface treatment section 16 includes a heating roller 85, a roller 86, a surface treatment belt 88 that is an endless belt stretched around the heating roller 85 and the roller 86, a cooling unit 90, a nip roller 92, and recording sheet detecting means 160. Note that in FIG. 1, illustration of the recording sheet detecting means 160 is omitted.

The surface treatment belt 88 is a belt that serves as the surface treatment means in the present invention and is a belt that is extremely high in surface (outer surface) smoothness. The heating roller 85 is a heating roller that generates heat to a temperature appropriate for heating the recording sheet A. The cooling unit 90 cools the surface treatment belt 88 by abutting the cooling unit 90 against the inner surface of the surface treatment belt 88 so that the recording sheet A being conveyed on the surface treatment belt 88 is cooled. Further, the nip roller 92 is abutted and pressed against the surface treatment belt 88 at the position corresponding to the heating roller 85, whereby the recording sheet A is pressed against the surface treatment belt 88 and is conveyed on the surface treatment belt 88 while being nipped between the roller 92 and the belt 88.

The heating means in the heating roller 85 and the cooling means in the cooling unit 90 are not specifically limited and any known means is usable.

The recording sheet detecting means 160 is means for detecting whether the recording sheet A exists in the surface treatment section 16, with reference to a result of detection of the recording sheet A by a sensor 160a disposed at the entrance of the surface treatment section 16 and a result of detection of the recording sheet A by a sensor 160b disposed at the exit of the surface treatment section 16. A method of detecting the recording sheet A is not specifically limited and every known sheet-like material detecting means such as an optical method is usable. The recording sheet detecting means 160 outputs a result of the detection, that is, the presence or absence of the recording sheet A at the surface treatment section 16, to the control unit 42.

As is apparent from FIGS. 1 and 2, the recording sheet A having an image fixed thereon is conveyed to the surface treatment section 16 with the image forming surface being faced the surface treatment belt 88.

In the surface treatment section 16, first, the recording sheet A is conveyed while being nipped between the surface treatment belt 88 (heating roller 85) and the nip roller 92, thereby abutting and pressing a surface of the recording sheet A (surface of the transparent resin layer of the photo-like print sheet) against a surface of the surface treatment belt 88 and heating the recording sheet A with the heating roller 85.

As a result of the heating/pressing, the transparent resin layer is melted to make the recording sheet A slightly stick to the surface treatment belt 88, and the recording sheet A is conveyed in this state on the surface treatment belt 88. In the surface treatment section 16, the cooling unit 90 cools the recording sheet A during its conveyance to solidify the melted transparent resin layer.

The thus cooled recording sheet A is peeled off the surface treatment belt 88 at the portion at which the surface treatment belt 88 turns around the roller 86 and is then supplied downstream.

In a case where the photo-like print sheet is used as the recording sheet A, the transparent resin layer (i.e., thermoplastic resin) on a surface of the recording sheet A is pressed against the surface treatment belt 88 to be heated/melted and then is cooled/solidified. As a result, the surface properties of the surface treatment belt 88 are transferred onto the transparent resin layer. As described above, the surface treatment belt 88 has extremely high surface smoothness. Therefore, the recording sheet A onto which the surface properties of the surface treatment belt 88 have been transferred becomes a sheet having high surface smoothness and favorable glossiness, whereby a print whose quality is as high as that of a silver halide photographic print can be obtained.

In the surface treatment of the recording sheet A, not only such a treatment for imparting glossiness but also various other surface treatments including matting (graining) can be performed by selecting the surface properties of the surface treatment belt 88.

In the illustrated printer 10, the heating and cooling conditions used in the surface treatment section 16 may be made adjustable so that the glossiness or other property to be imparted to the surface of the recording sheet A (print) can be adjusted.

In the illustrated embodiment, the recording sheet A is peeled off the surface treatment belt 88 by utilizing so-called stiffness of the recording sheet A. Accordingly, the peelability of the recording sheet A from the surface treatment belt 88 can be improved preferably by reducing, as shown in FIG. 1, the diameter of the roller 86 which is located at the position at which the recording sheet A is discharged from the surface treatment section 16 and around which the surface treatment belt 88 is stretched.

The recording sheet A having undergone the surface treatment in the surface treatment section 16 is then conveyed to the cutting subsection 102 of the cutting/arranging section 18 as described above.

The cutting/arranging section 18 includes the cutting subsection 102, the arranging subsection 104, and a sort conveying subsection 106.

The recording sheet A that was conveyed to the cutting/arranging section 18 after having undergone the surface treatment (for imparting glossiness) in the surface treatment section 16 is first cut in the cutting subsection 102 into a print size, whereby prints P (i.e. hard copies) to be outputted as products are obtained.

The cutting subsection 102 includes a first slitter 110, a second slitter 112, a guillotine cutter 114, a registration roller pair 116, a conveying path switching guide 150, a rear end scrap dropping guide 152, and a discharging unit 154. Note that in FIG. 1, illustration of the conveying path switching guide 150, the rear end scrap dropping guide 152, and the discharging unit 154 is omitted. The construction elements are connected to the control unit 42 and each operation is controlled by the control unit 42.

Also, the cutting subsection 102 includes a scrap container (not shown) below the trailing end of the discharging unit 154.

Each of the first slitter 110 and the second slitter 112 is a member for cutting the recording sheet A in the conveying direction and is a known slitter using, for example, a rotary cutter or a circular cutter.

Each of the first slitter 110 and the second slitter 112 includes two cutters that are arranged side by side in the width direction at the same position in the conveying direction and are positionally adjustable in the width direction. Further, the second slitter 112 is disposed downstream of the first slitter 110.

Each of the first slitter 110 and the second slitter 112 moves its respective cutters in the width direction in accordance with information about the width of the recording sheet A and information about the positions of images (i.e., information about the positions in the width direction), and cuts the conveyed recording sheet A in the conveying direction, thereby cutting the recording sheet A into sizes in the width direction of prints to be produced.

The image recording apparatus 10 records up to two images (i.e., performs imposition of up to two images) side by side in the width direction, for instance.

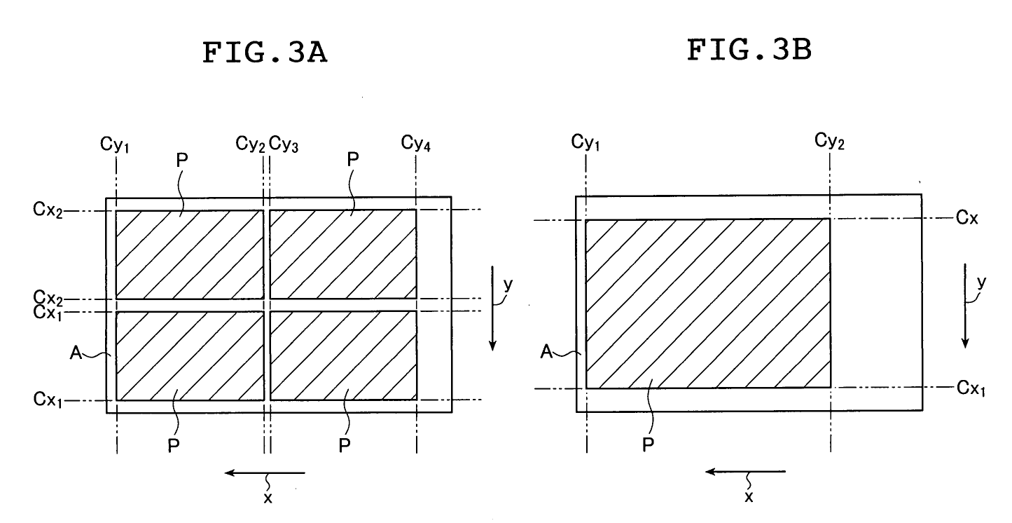

As shown in FIG. 3A, when two images have been recorded side by side in the width direction (i.e., direction of an arrow “y”), the respective cutters of the first slitter 110 are disposed to correspond to one image in the width direction, for instance, the image on the left side when viewed from an upstream side to a downstream side in the conveying direction (i.e., direction of arrow “x”), cut the recording sheet A along cutting lines Cx₁ while conveying the recording sheet A so that each image has the size of a corresponding print in the width direction. Also, the second slitter 112 on the downstream side is disposed so that its respective cutters correspond to the other image in the width direction, that is, an image on the right side when viewed from the upstream side to the downstream side in the conveying direction, cuts the recording sheet A along cutting lines Cx₂ while conveying the recording sheet A so that each image has the size of a corresponding print in the width direction.

That is, the images on the left side when viewed from the upstream side to the downstream side in the conveying direction are first cut out with the first slitter 110 and the images on the right side when viewed from the upstream side to the downstream side in the conveying direction are next cut out with the second slitter 112.

On the other hand, in a case where one image has been recorded in the width direction as shown in FIG. 3B, the second slitter 112 is retracted from the conveying path of the recording sheet A and the respective cutters of the first slitter 110 are disposed to correspond to the image recorded on the recording sheet A and cut the recording sheet A along cutting lines Cx₁ while conveying the recording sheet A, thereby cutting the image into the size in the width direction of a corresponding print.

The guillotine cutter 114 is a known guillotine cutter with which the recoding sheet A is cut in the width direction.

The registration roller pair 116 is a conveying roller pair with which the conveyance of the recording sheet A is stopped at the position at which the recording sheet A is to be cut by the guillotine cutter 114 in accordance with the information about the image position on the recording sheet A (information about the position in the conveying direction), in other words, the cutting position in the conveying direction of the recording sheet A is determined.

For instance, when two images have been recorded side by side in the conveying direction as shown in FIG. 3A, the registration roller pair 116 first stops the conveyance of the recording sheet A when a cutting line Cy₁ at the forward end of images on the forward side has reached the position at which the sheet is cut by the guillotine cutter 114. Next, the guillotine cutter 114 is actuated to cut the recording sheet A along the cutting line Cy₁.

After the cutting, the registration roller pair 116 resumes the conveyance of the recording sheet A and stops the conveyance of the recording sheet A when a cutting line Cy₂ at the rear end of the forward images has reached the position at which the sheet is cut by the guillotine cutter 114. Next, as in the above, the guillotine cutter 114 is actuated to cut the recording sheet A along the cutting line Cy₂. The recording sheet A has been cut in advance by the first slitter 110 and the second slitter 112 of the cutting subsection 102 along the cutting lines Cx₁ and the cutting lines Cx₂, so two prints P on the forward side are cut out by the guillotine cutter 114.

Following this, in a like manner, after the cutting, the registration roller pair 116 resumes the conveyance of the recording sheet A and stops the conveyance when a cutting line Cy₃ at the forward ends of the following images in the conveying direction have reached the position at which the sheet is cut by the guillotine cutter 114, and the guillotine cutter 114 cuts the recording sheet A along the cutting line Cy₃. Then, the registration roller pair 116 resumes the conveyance and stops the conveyance when a cutting line Cy₄ at the rear ends of the following images have reached the cutting position, and the guillotine cutter 114 cuts the recording sheet A along the cutting line Cy₄.

As a result of the cutting operation along the cutting lines Cy₃ and the cutting line Cy₄ as well as the cutting operation along the cutting lines Cx₁ and the cutting lines Cx₂, two prints P on the rear side are cut out as in the case of the two prints P on the forward side. Consequently, four prints P each of which corresponds to a print size and bears one of four images recorded on the recording sheet A are cut out.

On the other hand, when one image is recorded in the conveying direction as shown in FIG. 3B, the registration roller pair 116 stops the conveyance of the recording sheet A when a cutting line Cy₁ at the forward end of the image has reached the position at which the sheet is cut by the guillotine cutter 114. Then, the guillotine cutter 114 is actuated to cut the recording sheet A along the cutting line Cy₁.

After the cutting, the registration roller pair 116 resumes the conveyance of the recording sheet A and stops the conveyance of the recording sheet A when a cutting line Cy₂ at the rear end of the image has reached the position at which the sheet is cut by the guillotine cutter 114. Then, as in the above, the guillotine cutter 114 is actuated to cut the recording sheet A along the cutting line Cy₂. As described above, the recording sheet A has been cut in advance by the first slitter 110 of the cutting subsection 102 along the cutting lines Cx₁, so one print corresponding to a print size and bearing the image recorded on the recording sheet A is cut out as a result of the cutting operation by the guillotine cutter 114.

The conveying path switching guide 150 is known means for switching the conveying path for a sheet-like material such as a flapper that acts on (or is inserted into) the conveying path to thereby guide the recording sheet A to a predetermined conveying path.

The conveying path switching guide 150 changes the conveying destination of the recording sheet A after the treatment at the surface treatment section 16. The conveying path switching guide 150 switches the conveying path under control by the control unit 42 in accordance with which the recording sheet A conveyed from the surface treatment section 16 should be conveyed to the first slitter 110 or the discharging unit 154.

Meanwhile, the rear end scrap dropping guide 152 is an openable/closable guide for discharging portions other than a print area of the recording sheet A cut by the guillotine cutter 114 to the discharging unit 154.

The discharging unit 154 is a unit for conveying the sheet A other than the print area cut off by the first slitter 110, the second slitter 112, and the guillotine cutter 114, the recording sheet A conveyed to the discharging unit 154 by the conveying path switching guide 150, and the sheet A other than the print area discharged by the rear end scrap dropping guide 152, and for discharging the sheet A to the scrap container provided below the trailing end of the discharging unit 154. The discharging unit 154 is a belt conveyor including one pair of idlers 156 and an endless belt 158 stretched around the idlers 156. The sheet A other than the print area cut off by the first slitter 110, the second slitter 112, and the guillotine cutter 114, the recording sheet A conveyed from the conveying path switching guide 150, and the sheet A other than the print area discharged by the rear end scrap dropping guide 152 are conveyed to the scrap container (not shown) by the discharging unit 154. The conveying path switching guide 150 and the discharging unit 154 will be described in detail later.

The scrap container is a container for recovering scrap generated as a result of the cutting of the recording sheet A by the first slitter 110, the second slitter 112, and the guillotine cutter 114. The scrap container is provided below the trailing end of the discharging unit 154, as described above.

Each print P cut out from the recording sheet A at the cutting subsection 102 is next conveyed to the arranging subsection 104 and is further conveyed from the arranging subsection 104 to the sort conveying subsection 106.

The arranging subsection 104 is a subsection for discharging each print P cut in the cutting subsection 102 to the sort conveying subsection 106. When two images are recorded side by side in the width direction on the recording sheet A, the arranging subsection 104 unifies two lines of prints P that have been obtained in the width direction through cutting in the cutting subsection 102 into one line (or the print lines are unified) and discharges the unified prints P to the sort conveying subsection 106. In the illustrated example, the arranging subsection 104 includes an introducing roller pair 120, conveying roller pairs 122, 124, and 130, a discharging roller pair 126, and a line unifying roller pair 132.

The sort conveying subsection 106 is a belt conveyor including two rollers 140 and an endless belt 142 stretched around the rollers 140.

The introducing roller pair 120 of the arranging subsection 104 includes two roller pairs 120a and 120b that are arranged side by side in the width direction. The roller pairs 120a and 120b are each a pair of conveying rollers capable of being driven independently of each other.

When two images are recorded side by side in the width direction, the roller pair 120a that is one of the roller pairs of the introducing roller pair 120 serves to convey each print P (or is disposed at the position in the width direction of the print P) obtained through the cutting with the first slitter 110 along the cutting lines Cx₁. The roller pair 120b that is the other thereof serves to convey each print P (or is disposed at the position in the width direction of the print P) obtained through the cutting with the second slitter 112 along the cutting lines Cx₂.

The arranging subsection 104 includes a lower first conveying path 134 which branches downstream of the introducing roller pair 120 and includes the conveying roller pairs 122 and 124, and an upper second conveying path 136 including the conveying roller pair 130 and the line unifying roller pair 132. The line unifying roller pair 132 of the second conveying path 136 is a conveying roller pair that is movable in the width direction.

The conveying path on which the roller pair 120a is provided corresponds to the first conveying path 134, and the conveying path on which the roller pair 120b is provided corresponds to the second conveying path 136. A guide member (not shown) which acts on the conveying path from the roller pair 120a and optionally the roller pair 120b to guide the prints P to the first conveying path 134 is disposed at the position at which the above conveying path branches out into the first and second conveying paths.

In addition, the conveying paths 134, 136 join downstream of the conveying roller pair 124 and the conveying roller pair 132 by means of a guide member (not shown) to reach the discharging roller pair 126.

When two images have been recorded side by side in the width direction as shown in FIG. 3A, the guide member is caused to act only on the conveying path from the roller pair 120a of the introducing roller pair 120.

Two lines of the cut prints P disposed in the width direction are conveyed to the arranging subsection 104, where the prints P cut by the first slitter 110 are conveyed to the first conveying path 134 by the roller pair 120a and the guide member and the prints P cut by the second slitter 112 are conveyed to the second conveying path 136 by the roller pair 120b.

The prints P conveyed to the first conveying path 134 are supplied through the conveying roller pairs 122 and 124 to the discharging roller pair 126, from which the prints P are then discharged to the sort conveying subsection 106.

On the other hand, when the conveyed print P has been nipped between the line unifying roller pair 132 of the second conveying path 136, the conveyance is stopped (similarly, roller pair 120b is also stopped). Next, after the conveying roller pair 120 is placed in a released state as necessary, the line unifying roller pair 132 is moved in the width direction, thereby moving the print P to a position in the width direction corresponding to the roller pair 120a. After the movement in the width direction, the line unifying roller pair 132 and optionally the conveying roller pair 130 start conveying the print P in synchronization with the conveyance to the discharging roller pair 126 of the print P having been supplied to the first conveying path 134 so that each set of the prints P disposed side by side are sequentially conveyed to the discharging roller pair 126. Next, the discharging roller pair 126 discharges the print P to the sort conveying subsection 106.

In the example shown in FIG. 3A, two prints P have been formed side by side also in the conveying direction.

In this case, when the preceding print P has passed through the line unifying roller pair 132, the line unifying roller pair 132 is moved backward in the width direction to return to the original position. Next, the following print P is conveyed from the roller pair 120b to the second conveying path 136. As in the case described above, when the print P is nipped between the line unifying roller pair 132, the conveyance in the second conveying path 136 to which the print P has been conveyed is stopped and the conveying roller pair 130 is placed in the released state as necessary. Next, the line unifying roller pair 132 is moved in the width direction, thereby moving the print P to the position in the width direction corresponding to the roller pair 120a. Then, the print P is conveyed by the line unifying roller pair 132 and optionally the conveying roller pair 130 and then discharged to the sort conveying subsection 106 by the discharging roller pair 126.

As a result, two or more lines of prints P arranged in the width direction are unified into one line and then discharged to the sort conveying subsection 106.

There is also a case where, in the printer 10, panoramic-sized prints or other long-sized two prints are formed side by side in the width direction, that is, prints in a state where the two prints P arranged side by side in the conveying direction (indicated by the arrow “y”) in FIG. 2A are connected to each other are formed.

In this case, when the print P is nipped between the line unifying roller pair 132 in the second conveying path 136, the conveying roller pair 130 and optionally the roller pair 120b release the print P. Next, the line unifying roller pair 132 is moved in the width direction, thereby moving the print to the position in the width direction corresponding to the roller pair 120a. Following this, the print P is conveyed by the conveying roller pair 130 and the line unifying roller pair 132 while being nipped between the conveying roller pair 130 and optionally the roller pair 120b. The print P is then discharged to the sort conveying subsection 106 through the discharging roller pair 126.

This operation enables the panoramic-sized prints or other long-sized prints arranged in two or more lines to be advantageously unified into one line.

In contrast to this, when one image has been recorded in the width direction as shown in FIG. 3B, the guide member is caused to act on both of the conveying path from the roller pair 120a and the conveying path from the roller pair 120b.

When the cut print P is conveyed to the arranging subsection 104, the introducing roller pair 120 whose roller pairs 120a and 120b are driven in synchronism, and the guide member convey the print P to the first conveying path 134, where the print P is conveyed through the conveying roller pairs 122 and 124 to the discharging roller pair 126 and is then discharged to the sort conveying subsection 106 through the discharging roller pair 126.

The sort conveying subsection 106 receives the prints P conveyed through and discharged/dropped from the discharging roller pair 126 and stacks the prints P on the belt conveyor. Then, when it is confirmed based on sort information that prints for one order have been stacked thereon, the sort conveying subsection 106 conveys the stack of the prints P by a predetermined distance set in accordance with the print size (maximum print length in the processed order) and stops the conveyance. Then, the sort conveying subsection 106 receives the prints P for the next order.

Next, a print conveying method and discharging method at the time of occurrence of abnormality in the image recording apparatus in this embodiment will be described.

In the image recording apparatus 10, when each kind of sensors described above detects abnormality (trouble) such as jamming, this information is supplied to the control unit 42. In response to the information, the control unit 42 receives a result of the detection, that is, the presence or absence of the recording sheet A in the surface treatment section 16, by the recording sheet detecting means 160. Following this, when the recording sheet A exists in the surface treatment section 16, the control unit 42 identifies whether the recording sheet A which is being subjected to the surface treatment at the surface treatment section 16 is the photo-like print sheet described above, with reference to a result of the recording sheet kind detection by the loaded sheet kind detecting means 162 and recording sheet A supply instruction outputted to the supplying section 12 by the control unit 42 itself. Also, in accordance with a result of the recording sheet A detection by each kind of sensors, the control unit 42 identifies the abnormality occurrence site.

Further, the control unit 42 controls the driving of the surface treatment section 16, the driving of the upstream unit (i.e., on the upstream side with respect to the surface treatment section 16), and the driving of the downstream unit (i.e., on the downstream side with respect to the surface treatment section 16), in accordance with the presence or absence of the recording sheet A in the surface treatment section 16, a result of the recording sheet kind identification (i.e., whether the recording sheet A is the photo-like print sheet) when the recording sheet A exists in the surface treatment section 16, and the abnormality occurrence site at the time of the occurrence of the abnormality.

When abnormality occurs and no recording sheet A exists in the surface treatment section 16, the control unit 42 stops the driving of the upstream unit. Then, when the abnormality occurrence site is in the upstream unit, print production is continued at the downstream unit and the prints produced are discharged to the sort conveying subsection 106. On the other hand, when the abnormality occurrence site is in the downstream unit, driving on an upstream side with respect to the abnormality occurrence site is stopped, driving on a downstream side with respect to the abnormality occurrence site is continued to produce prints, and the prints are discharged to the sort conveying subsection 106. When every print which can be outputted at the downstream unit is discharged to the sort conveying subsection 106, every driving is stopped and displaying on a display or the like is performed to urge a user to handle the abnormality such as jamming. Alternatively, when the abnormality occurrence site is in the downstream unit, both of the driving of the upstream unit and the driving of the downstream unit may be stopped to urge the user to handle the abnormality.

When abnormality occurs and the recording sheet A (e.g., a part or the whole thereof) exists in the surface treatment section 16, the control unit 42 performs treatment which is different depending upon whether the recording sheet A in the surface treatment section 16 is a photo-like print sheet or whether the abnormality occurrence site is in the upstream unit or the downstream unit as well as whether the recording sheet A in the surface treatment section 16 is a photo-like print sheet.

When abnormality occurs and a photo-like print sheet exists in the surface treatment section 16, and further, when the abnormality occurrence site is in the upstream unit, the control unit 42 stops the driving of the upstream unit and continues stationary treatment at the surface treatment section 16 and the downstream unit. When the surface treatment to the recording sheet A existing in the surface treatment section 16 at the time of the occurrence of the abnormality has finished, cutting and optionally line unification has finished, and every print existing at the surface treatment section 16 and the downstream unit has been discharged to the sort conveying subsection 106, every driving is stopped and displaying on a display or the like is performed to urge a user to handle the abnormality such as jamming.

On the other hand, when abnormality occurs and a photo-like print sheet exists in the surface treatment section 16, and further, when the abnormality occurrence site is in the downstream unit, the control unit 42 stops the driving of the upstream unit and the driving of the downstream unit, but driving of the cutting subsection 102 is continued in some cases, and continues stationary treatment at the surface treatment section 16. Also, the control unit 42 drives the discharging unit 154 and switches the conveying path switching guide 150.

That is, the control unit 42 switches the conveying path switching guide 150 so that the conveying path is faced toward the discharging unit 154. The recording sheet A, a part or whole of which exists in the surface treatment section 16, is guided to the discharging unit 154 by the conveying path switching guide 150 and is discharged from the discharging unit 154 to the scrap container.

It should be noted here that depending on the timing of the jamming or the size of the recording sheet A, there is also a case where the leading end of the recording sheet A existing in the surface treatment section 16 exceeds the conveying path switching guide 150. In this case, the recording sheet A in the surface treatment section 16 may be conveyed to the cutting subsection 102, shredded with the guillotine cutter 114, and discharged from the rear end scrap dropping guide 152 to the discharging unit 154. Alternatively, a conveying guide disposed on a conveying path on a downstream side of the guillotine cutter 114 may be opened and the recording sheet A may be discharged therefrom.

The discharging unit 154 moves the endless belt 158 by rotating the idlers 156 and conveys the recording sheet A on the endless belt 158 to the scrap container. The control unit 42 stops the operation of the surface treatment section 16 when every recording sheet A existing in the surface treatment section 16 has been discharged to the discharging unit 154.

Also, the driving on the upstream side with respect to the abnormality occurrence site may be stopped and driving on the downstream side with respect to the abnormality occurrence site may be continued. In this case, when every print which can be outputted on the downstream side with respect to the abnormality occurrence site has been discharged to the sort conveying subsection 106, every driving is stopped and displaying on a display or the like is performed to urge a user to handle the abnormality such as jamming.

When abnormality occurs and a recording sheet A other than the photo-like print sheet exists in the surface treatment section 16, the control unit 42 stops every driving in the image recording apparatus 10 and urges a user to handle the abnormality such as jamming through displaying on a display or the like.

Alternatively, the control unit 42 may stop the driving on the upstream side with respect to the abnormality occurrence site and may continue the driving on the downstream side with respect to the abnormality occurrence site. In this case, when every print which can be outputted on the downstream side with respect to the abnormality occurrence site has been discharged to the sort conveying subsection 106, every driving is stopped and displaying on a display or the like is performed to urge a user to handle the abnormality such as jamming.

In the image recording apparatus according to the present invention, the presence or absence of the recording sheet A and the kind of the recording sheet A in the surface treatment section 16 are detected at the time of occurrence of a trouble, and the driving on the upstream side of the surface treatment section 16 and the driving of the downstream unit are controlled in accordance with a result of the detection. Therefore, it becomes possible to conduct control so that at the time of occurrence of abnormality, conveyance of the recording sheet A existing in the surface treatment section 16 under a heated/pressurized state is continued to preferentially remove the recording sheet A by performing accurate error control in accordance with the site of the abnormality and the presence or absence and the kind of the recording sheet A in the surface treatment section 16. Accordingly, it becomes possible to prevent deterioration in smoothness of the belt of the surface treatment section 16 due to adhesion of a resin or the like and other inconveniences.

The image recording apparatus according to the present invention has been described in detail above. However, the present invention is not limited to the embodiment described above and it is of course possible to make various modifications and changes without departing from the gist of the present invention.

What is claimed is:

1. An image recording apparatus including:
image recording means for recording an image on a surface of a recording sheet;
surface treatment means for performing surface treatment using a belt on the surface of the recording sheet on which the image is recorded when the recording sheet is a surface-treatable recording sheet having a surface on which the surface treatment can be performed;
recording sheet discriminating means for detecting whether the recording sheet exists in the surface treatment means and discriminating whether the recording sheet in the surface treatment means is the surface-treatable recording sheet;
abnormality occurrence site identifying means for detecting occurrence of abnormality and identifying an abnormality occurrence site; and
control means for controlling, when the occurrence of the abnormality has been detected by the abnormality occurrence site identifying means, driving of the surface treatment means, driving of an upstream unit having the image recording means on an upstream side with respect to the surface treatment means, and driving of a downstream unit on a downstream side with respect to the surface treatment means, in accordance with the abnormality occurrence site identified by the abnormality occurrence site identifying means, a result of the detection by the recording sheet discriminating means of whether the recording sheet exists in the surface treatment means, and a result of the discrimination by the recording sheet discriminating means of whether the recording sheet in the surface treatment means is the surface-treatable recording sheet.

2. The image recording apparatus according to claim 1, wherein, when the abnormality occurrence site identifying means detects the occurrence of the abnormality and the recording sheet discriminating means detects that no recording sheet exists in the surface treatment means, the control means stops conveyance at least at the upstream unit.

3. The image recording apparatus according to claim 1, wherein, when the abnormality occurrence site identifying means detects the occurrence of the abnormality, the recording sheet discriminating means detects that the recording sheet corresponding to the surface-treatable recording sheet exists in the surface treatment means, and the abnormality occurrence site identifying means identifies that an abnormality occurrence site is the upstream unit, the control means stops the driving of the upstream unit and drives the surface treatment means until the recording sheet has been discharged.

4. The image recording apparatus according to claim 1, wherein, when the abnormality occurrence site identifying means detects the occurrence of the abnormality, the recording sheet discriminating means detects that the recording sheet corresponding to the surface-treatable recording sheet exists in the surface treatment means, and the abnormality occurrence site identifying means identifies that the abnormality occurrence site is the downstream unit, the control means stops the driving of the upstream unit, switches a conveying path using a conveying path switching guide provided on a downstream side of the surface treatment means, and discharges the recording sheet in the surface treatment means to a predetermined discharging portion.

5. The image recording apparatus according to claim 1, wherein, when the abnormality occurrence site identifying means detects the occurrence of the abnormality and the recording sheet discriminating means detects that the recording sheet not corresponding to the surface-treatable recording sheet exists in the surface treatment means, the control means stops all the conveyances at the upstream unit, the downstream unit, and the surface treatment means.

6. The image recording apparatus according to claim 1, wherein, when the abnormality occurrence site identifying means detects the occurrence of the abnormality and the recording sheet discriminating means detects that the recording sheet not corresponding to the surface-treatable recording sheet exists in the surface treatment means, the control means stops the conveyance on the upstream side with respect to the abnormality occurrence site identified by the abnormality occurrence site identifying means, and drives the downstream side with respect to the abnormality occurrence site identified by the abnormality occurrence site identifying means until the recording sheet has been discharged.
